(19) United States
(12) Patent Application Publication
(10) Pub. No.: US 2024/0401983 A1
(43) Pub. Date: Dec. 5, 2024

(54) Operating a Resolver

(71) Applicant: ABB Schweiz AG, Baden (CH)

(72) Inventors: Richard Roberts, Gilching (DE); Werner Hösl, Nabburg (DE)

(73) Assignee: ABB Schweiz AG, Baden (CH)

(21) Appl. No.: 18/798,228

(22) Filed: Aug. 8, 2024

Related U.S. Application Data
(63) Continuation of application No. PCT/EP2022/053091, filed on Feb. 9, 2022.

(51) Int. Cl. G01D 5/20; G01B 7/00; G01B 7/30; G01D 3/08

(52) U.S. Cl. CPC G01D 5/2073; G01B 7/003; G01B 7/30; G01D 3/08

(57) ABSTRACT

A method for operating a resolver, the resolver comprising at least one stator winding and at least one rotor winding which is rotatable with respect to said at least one stator winding and inductively coupled thereto, a monitoring phase of the method comprising: a) exciting the rotor winding with an alternating current, b) deriving a first sampling voltage value by sampling a voltage induced in the at least one stator winding by the alternating current flowing in the rotor winding at a predetermined first phase of the excitation current, and c) deciding that the resolver is defective when the first sampling voltage value deviates significantly from a DC component of the induced voltage.

### CROSS-REFERENCE TO RELATED APPLICATIONS

The instant application claims priority to International Patent Application No. PCT/EP2022/053091, filed Feb. 9, 2022, which is incorporated herein in its entirety by reference.

### FIELD OF THE DISCLOSURE

The present disclosure generally relates to methods and apparatus for operating a resolver and, more particularly, to operating a resolver associated with a joint in an articulated robot arm.

### BACKGROUND OF THE INVENTION

An articulated robot arm comprises a plurality of links, which are coupled to each other, to a base or to an end effector by rotatable joints. A link of such a robot arm usually houses a motor and a gear for driving the rotation of a neighboring joint, and power and signal wires for the motor of this link and for motors of more distal links and, possibly, of the end effector. In operation, movement of the robot tends to wear on the isolation of the wires. In many cases, the isolation will not break down abruptly, but its resistance will decrease gradually, thereby distorting measurement signals that are fed back to a controller. Such distortion can cause the controller to derive from the measurement signals a position of the robot that differs from the real position. Such a deviation not only affects the precision with which the robot can carry out a given task but also harbingers total breakdown of the isolation which, when it occurs, can cause the robot to carry out unpredictable movements that can endanger people in its vicinity.

Conventionally, a resolver comprises so-called rotor and stator windings, which are rotatable with respect to each other and are inductively coupled so that when an alternating current is flowing in at least one rotor winding, an alternating voltage will be induced in at least one stator winding. Conventionally, a resolver has two stator windings arranged at right angles to each other, so that when θ denotes an orientation angle of the rotor, induction in one of the stator windings is proportional to sin θ whereas in the other it is proportional to cos θ. These windings will therefore also be referred to as sine winding and cosine winding, respectively.

When the resolver is operating normally, total coupling between the rotor and stator windings does not depend on the relative orientation of the windings, i.e. the Pythagorean sum \sqrt{Uₛ²+U_{c}²}, of the voltage amplitudes Us, Uc induced in sine and cosine windings of the stator is independent of the orientation of the rotor. When there is a defect in the insulation of wires associated with one of the stator windings, part or all off the voltage induced in it may be short circuited, so that a defect in insulation can be detected based on a variation of said sum. However, since the signal that must be evaluated in order to detect the defect is a sum of contributions from two windings, which will in most cases not become defective at the same time, the defect becomes the hard to detect the smaller the contribution from the defective winding is.

Evidently, when the rotor winding is orthogonal to the defective stator winding, no voltage is induced in the latter, and the defect cannot be detected. When the rotor rotates out of the orthogonal orientation, the amplitude of the alternating voltage induced in the intact stator winding will decrease in proportion to the cosine of the misalignment angle, whereas in the defective winding it fails to increase. If the threshold for detection of a failure is set at e.g. 95% of the nominal value of the above sum, the rotor will have to rotate by θ=12.9° until the failure is detected if the voltage induced in the defective winding is shunted completely. In practice, due to manufacturing tolerances, temperature effects and the like, a more generous threshold may be necessary. If the failure threshold is set at 80%, position detection by the resolver can be wrong by up to 0=±36.9° before a malfunction of the resolver is detected.

If the induced voltage isn't shunted completely, i.e. if the insulation has a nonzero residual resistance, the angle by which the resolver can rotate before the malfunction is detected can still be larger. Therefore, when insulation gradually wears down, the defect can at first go completely unnoticed, merely causing a loss of accuracy in the movement of the robot, and, hence, a decrease in product quality.

### BRIEF SUMMARY OF THE INVENTION

There is thus a need, in particular in collaborative robot applications, for a resolver and for a resolver operating method by which such a deterioration can be detected at an early stage. This need is satisfied, according to an aspect of the present disclosure, by a method for operating a resolver, the resolver comprising at least one stator winding and at least one rotor winding which is rotatable with respect to said stator winding and inductively coupled thereto, wherein a monitoring phase of the method comprises the steps of a) exciting the rotor winding with an alternating current, b) deriving a first sampling voltage value by sampling a voltage induced in the at least one stator winding by the alternating current flowing in the rotor winding at a predetermined first phase of the excitation current, c) deciding that the resolver is defective if the first sampling voltage value deviates significantly from a DC component of the induced voltage.

When the predetermined first phase has initially been chosen so that for an intact resolver a sample of the induced voltage taken at that phase is equal to the DC component, any subsequent phase shift of the voltage induced in the stator winding will cause the sample to become different from the DC component. Since the decision can be based on measurements taken at the winding in question alone, a higher sensitivity can be achieved than in the above-discussed conventional case of monitoring the Pythagorean sum of voltages induced in different windings.

### BRIEF DESCRIPTION OF THE SEVERAL VIEWS OF THE DRAWING(S)

FIG. 1 is a schematic view of a robot and its controller in accordance with the disclosure.

FIG. 2 is a schematic diagram of a resolver in accordance with the disclosure.

FIG. 3 is a block diagram of the robot and its controller according to an embodiment of the present disclosure.

FIG. 4 is a waveform diagram of excitation currents and induced voltages during initialization and normal operation of the controller in accordance with the disclosure.

### DETAILED DESCRIPTION OF THE INVENTION

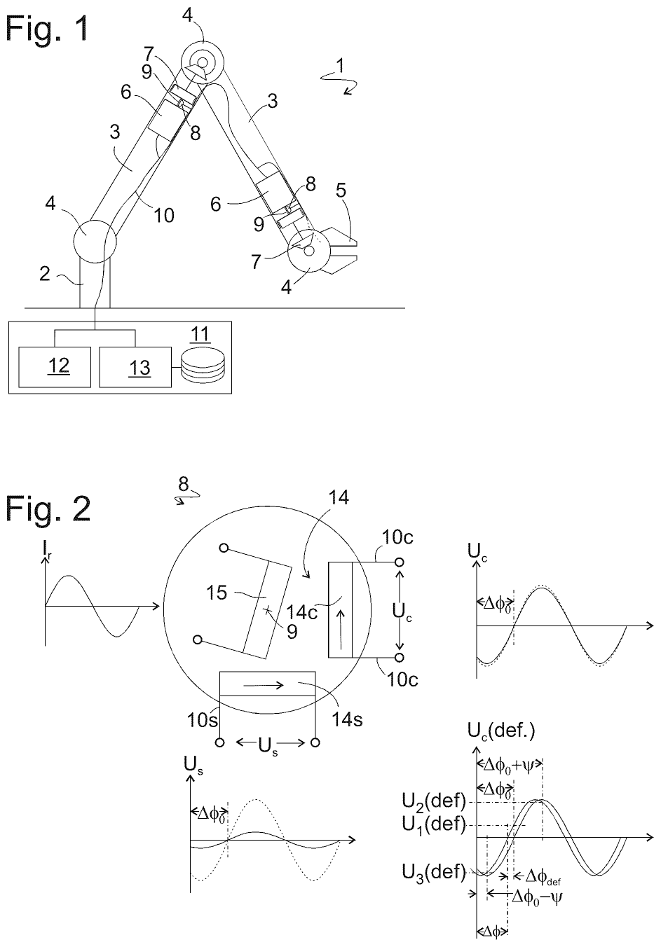

FIG. 1 is a schematic view of a robot system comprising an articulated robot arm 1. The robot arm 1 has a stationary base 2 fixed to a support, and a plurality of links 3 rotatably connected to each other and to the base 2 by joints 4. The most distal link carries an end effector 5. The links 3 are shown with part of their casing removed, so that motors 6 and gears 7 for driving rotation of the joints 4 can be seen inside the casing. A resolver for measuring a rotation position could be mounted at the axis of rotation of each joint 4; in the embodiment of FIG. 1 a resolver 8 is mounted at a shaft 9 extending from the motor 6 to the reducing gear 7.

A wire harness 10 extends along the articulated arm 1 between a controller 11 on one end and the motors 6 and resolvers 8 on the other, supplying the motors 6 with energy from a power supply circuit 12, and feeding back output from the resolvers 8 to a processor 13. The wire harness 10 must adapt to every movement of the robot arm 1, which may wear down the isolation of individual wires in it.

FIG. 2 is a schematic diagram of one of said resolvers 8. The resolver 8 has stator windings 14s, 14c, also referred to here as sine winding 14s and cosine winding 14c, whose axes extend at right angles to one another in a plane, and a rotor winding 15 which is rotatable with respect to the stator windings around an axis of rotation perpendicular to said plane.

Power supply circuit 12 feeds an exciting current Ir to rotor winding 15 by wires of harness 10. The exciting current Ir has an oscillation frequency which is much higher than a rated maximum rotating frequency of the motor 6, e.g. between 1 and 10 kHz, so that in a cycle of the exciting current, rotation of the shaft 9 is negligible. The exciting current Ir induces alternating voltages Us, Uc in sine winding 14s and cosine winding 14c, respectively.

When the resolver is operating correctly, the two voltages differ in amplitude depending on the instantaneous orientation of the rotor, i.e. in the configuration shown, with the rotor winding 15 nearly parallel to cosine winding 14c and nearly orthogonal to sine winding 14s, the amplitude of Uc is near maximum, represented by a dotted curve, whereas Us is close to zero, and phases of Us, Uc are shifted with respect to Ir by substantially the same amount Ayo, referred to as the nominal phase shift.

While a small load on Uc due to an insulation defect in the wires 10c extending between the cosine winding 14c and the controller 11 may not have a significant influence on the amplitude of Uc, it may cause the actual phase shift Δ_{φ} to differ noticeably, by Δ_{φdef}, from the nominal phase shift Δ_{φ0}, as shown in 10 the diagram Uc(def.) of FIG. 2. Of course, an insulation defect in wires 10s leading to the sine winding 14s would have the same effect on Us.

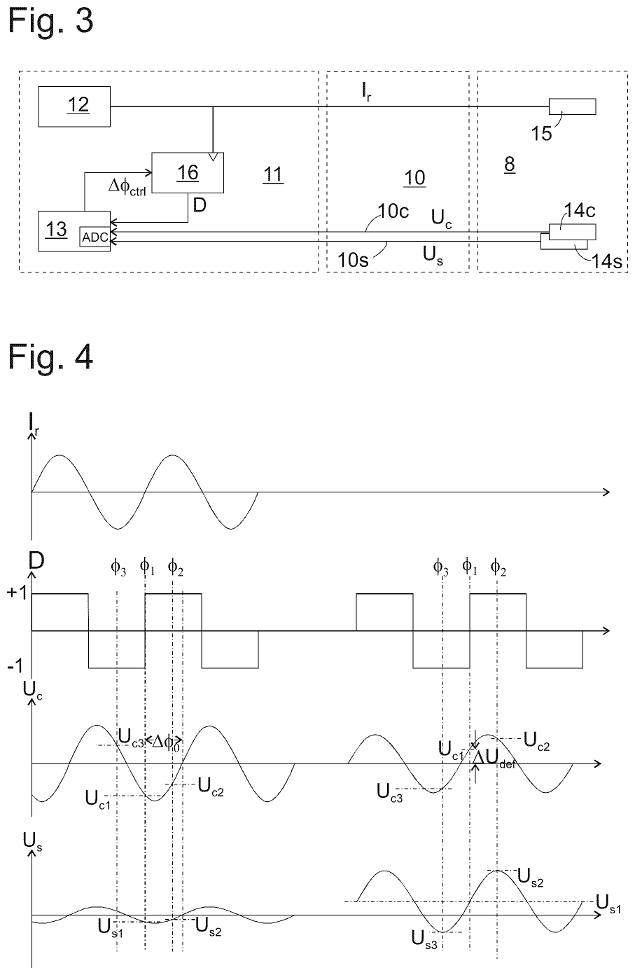

FIG. 3 is a block diagram of the controller 11, the wire harness 10 and the resolver 8. Circuit 16 of controller 11 may be an oscillator that is weakly coupled to the output of power supply circuit 12, so as to produce an output signal D having the same frequency as Ir. From processor 13, circuit 16 receives a control signal which defines a desired phase shift Δ_{φctrl} between Ir and D.

Circuit 16 may be implemented in a variety of ways, e.g. in the form of a phase-locked loop, or of a programmable counter designed to count between zero and an initialization value set by the control signal from processor 13 after having been triggered by e.g. a zero crossing of Ir, and to toggle output signal D between 1 and −1 each time it finishes counting.

When controller 11 starts up for the first time, it is assumed that resolver 8 is free from defects. The control signal Δ_{φctrl} provided by processor 13 to circuit 16 may have any value, causing an unknown phase shift between Uc (or Us) and D.

The excitation current Ir reaching a predetermined first phase φ1 of its oscillation causes signal D to toggle from −1 to +1. This in turn triggers the processor to take samples Uc1 and Us1 of Uc and Us, respectively. In FIG. 4, this first phase is a zero crossing on the rising flank of the Ir waveform, but this is merely a coincidence, not a necessity.

The diagram of FIG. 4 illustrates a situation where the rotor is oriented so that induction in the cosine winding 14c is stronger than in the sine winding 14s. Assuming that when the resolver 8 is intact, voltages Uc and Us will have the same phase shift with respect to Ir, the weaker one of the two induced voltages can be disregarded, basing subsequent processing on the higher voltage Uc alone, or on the Pythagorean sum \sqrt{Uₛ²+U_{c}²} of both.

When the excitation current Ir reaches a predetermined second phase φ2=φ1+ψ, the processor takes second samples Uc2 and Us2 of Uc and Us, respectively. Preferably, ψ=π, since in that case the phase shift Δ_{φ0} between Ir and Uc, Us is tan⁻¹ U2/U1, where Ui, i=1, 2 can be either Uci, Usi or \sqrt{Uₛᵢ²+U_{ci}²}, depending on the relative amplitudes of Uc and Us.

There is the possibility that external circuitry connected to windings 14s, 14c causes a DC component in Uc or Us. When ψ=π, biasing by such a DC component can be avoided by taking third samples Uc3 and Us3 at third phases φ3=φ1−ψ. Averages 1/2(U_{c2}+U_{c3}) and 1/2(Uₛ₂+Uₛ₃) then equal DC components DCc, DCs of Uc and Us, respectively, and the phase shift can is given by Δϕ0=tan⁻¹(U₂−DC)/(U₁−DC).

Samples Ui can be taken in several cycles of the excitation current and averaged, prior to calculating the phase shift Δ_{φ0} from the average.

The initialization procedure ends by processor 13 changing the value of the control signal by Δ_{φ0}. Thus, toggling times of D come to coincide with zero crossings of Uc and Us, as shown with respect to Us in the right hand part of FIG. 4.

Monitoring of the resolver 8 will be explained referring to the right hand part of FIG. 4. It is assumed that the orientation of the rotor has changed, so that amplitudes of Uc and Us are roughly similar in this part of the drawing. It should be noted that this is merely to make the effects to be discussed more clearly visible in the drawing, the method of the invention does not require a change of orientation of the rotor.

It is assumed here that the sine winding 14s and its wiring 10s is intact. Us has a DC component, but this is not symptomatic of a defect. Rather it is due to external circuitry connected to the winding 14s. The phase of Us hasn't changed since the initialization phase. Therefore, Uₛ₁−1/2(Uₛ₂+Uₛ₃)=0, and no defect of winding 14s is detected. On the other hand, in cosine winding 14c has shifted since initialization. (In practice, being connected to the same type of circuitry as sine winding 14s, cosine winding can be expected to have the same DC component, but for the sake of simplicity, it is not shown in FIG. 4.). The phase shift causes a noticeable difference ΔUdef between the first sample Uc1 and the DC component. This difference may be averaged or low-pass filtered over several cycles of Ir. When this difference exceeds a predetermined percentage of the amplitude of Uc at the present rotor orientation, the processor 13 judges the resolver 8 to be defective.

In the present disclosure, while the resolver (8) is operating normally, voltage samples Us2, Uc2 or Us3, Uc3 are proportional or in case of ψ=π, identical to the amplitudes of the induced voltages Us, Uc. Therefore, the processor 13 can calculate an orientation angle θ of the rotor directly from the ratio of the voltage samples using the relationship θ=tan⁻¹ Us2/Uc2 or θ=tan⁻¹ Us3/Uc3.

When no biasing circuitry is connected to the at least one stator winding, the DC component is zero, so that even a small deviation of the first sampling voltage value from said DC component can be detected reliably. The influence of noise can be reduced when in step b) the sampling voltage value is derived from samples of the induced voltage taken at the first phase of several cycles of the alternating current, in particular by low-pass filtering.

Sensitivity of the method to external disturbances such as induction by magnetic fields external to the resolver, the DC component can be measured in real time, concurrently with taking samples at the above-mentioned first phase of the excitation current.

A preferred way of doing so is by sampling said voltage induced in the at least one stator winding at second and third phases of the excitation current in order to derive second and third sampling voltage values, wherein a difference between said first and second phases equals a difference between said third and first phases. As long as the first phase coincides with the induced voltage crossing the DC component level, the difference between the second sampling voltage and the DC component level should have the 25 same amount but a sign different from that of the difference between the third sampling voltage and the DC component level; in other words, the average of the second and third sampling voltage values should be identical to the DC component level; if it isn't, the phase of the induced voltage must have changed, and it must be concluded that the winding is defective.

Maximum sensitivity for a phase change is achieved when the difference between said first and second (or third and first) phases is γ/2 radians.

In a simple embodiment, sampled voltages can be evaluated directly, by judging a deviation to be significant when the difference between the first sampling voltage value and the DC component exceeds a predetermined voltage threshold.

When second or third sampling voltage values are obtained, a phase shift of the induced voltage (Us, Uc) with respect to the excitation current can be derived from said first and second or first and third sampling voltage values, and the first sampling voltage value can be judged to deviate significantly from the DC component when said derived phase shift differs from said first phase by more than a predetermined phase threshold.

The above-mentioned first phase can be assumed to depend on the design of the resolver and to have a same value for all resolvers of identical design. In that case, the first phase can be determined once and for all by calculation or by measuring a prototype resolver. In order to take account of manufacturing tolerances of the resolver and of influences of its operating environment, it can be preferable to measure the first phase individually for each resolver and then to set the result of the measurement as the predetermined phase. Both approaches can be combined by measuring the first phase individually for each resolver, comparing the result with an expected value, setting the result of the measurement as the predetermined phase only when the result is within a given tolerance range around the expected value, and else rejecting the resolver as defective.

According to a preferred embodiment of the invention this is done in an initialization phase of the method comprising steps of a′) exciting the rotor winding with an alternating current (Ir), b′) setting a sampling phase, c′) sampling, at said sampling phase, a voltage induced in the at least one stator winding by the alternating current flowing in the rotor winding (15), in order to derive an initialization sampling voltage value and, d′) if the first sampling voltage value deviates significantly from a DC component of the induced voltage, changing the sampling phase and repeating step c′).

The sampling phase can be set in step b′ in a completely arbitrary way, without any prior knowledge of what the actual phase shift between excitation current and induced voltage might be in the resolver to which the method is applied.

The actual phase shift for a specific resolver can be found in a quick and efficient way by e′) sampling said voltage induced in the at least one stator winding at a second phase different from the first phase, in order to derive second sampling voltage values, f′) deriving from said first and second sampling voltage values a phase shift of the induced voltage with respect to the excitation current, and g′) changing the sampling phase by the phase shift derived in step f).

According to a second aspect, the invention provides a resolver controller comprising a power supply for providing an alternating current to a rotor winding of a resolver, and a processor adapted to derive a first sampling value by sampling a voltage induced in the at least one stator winding by the alternating current flowing in the rotor at a predetermined first phase of the excitation current; and to decide that the resolver is defective if the first sampling voltage value deviates significantly from a DC component of the induced voltage.

The same controller may comprise calculating means for deducing an angular position of the resolver from voltages sampled from said stator windings. According to a further aspect, the invention provides a resolver assembly comprising the resolver controller as defined above and an associated resolver. Such an assembly can further comprise an articulated robot arm having a joint to which the resolver is associated.

According to a still further aspect, the invention can be embodied in a computer-readable storage medium having stored thereon a plurality of instructions which, when executed by a processor, cause the processor derive a first sampling value by sampling a voltage induced in the at least one stator winding by the alternating current flowing in the rotor at a predetermined first phase of the excitation current; and to decide that the resolver is defective if the first sampling voltage value deviates significantly from a DC component of the induced voltage.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method for operating a resolver, the resolver comprising at least one stator winding and at least one rotor winding which is rotatable with respect to said at least one stator winding and inductively coupled thereto, a monitoring phase of the method comprising:
a) exciting the rotor winding with an alternating current,
b) deriving a first sampling voltage value by sampling a voltage induced in the at least one stator winding by the alternating current flowing in the rotor winding at a predetermined first phase of the excitation current,
c) deciding that the resolver is defective when the first sampling voltage value deviates significantly from a DC component of the induced voltage.

2. The method of claim 1, wherein in step b) the sampling voltage value is derived from samples of the induced voltage taken at the first phase of several cycles of the alternating current.

3. The method of claim 1, further comprising:
d) sampling said voltage induced in the at least one stator winding at second and third phases to derive second and third sampling voltage values,
wherein a difference between said first and second phases equals a difference between said third and first phases,
wherein the DC component is derived from a sum of the second and third sampling voltage values.

4. The method of claim 3, wherein the difference between the first and second phases is π/2.

5. The method of claim 1, wherein the first sampling voltage value is judged to deviate significantly from the DC component when the difference between the first sampling voltage value and the DC component exceeds a predetermined voltage threshold.

6. The method of claim 3, further comprising deriving from at least two of the first to third sampling voltage values a phase shift of the induced voltage with respect to the excitation current, and wherein the first sampling voltage value is judged to deviate significantly from the DC component when said derived phase shift differs from the first phase by more than a predetermined phase threshold.

7. The method of claim 1, wherein an initialization phase of the method comprises:
a′) exciting the rotor winding with an alternating current,
b′) setting a sampling phase,
c′) sampling, at said sampling phase, a voltage induced in the at least one stator winding by the alternating current flowing in the rotor winding to derive a first initialization sampling voltage value, and
d′) when the first initialization sampling voltage value deviates significantly from a DC component of the induced voltage, changing the sampling phase and repeating step c′).

8. The method of claim 7, wherein the initialization phase further comprises:
e′) sampling said voltage induced in the at least one stator winding at a second phase different from the first phase to derive second initialization sampling voltage values,
f′) deriving from said first and second sampling initialization voltage values a phase shift of the induced voltage with respect to the excitation current, and
g′) changing the sampling phase by the phase shift derived in step f′).

9. A resolver controller comprising a power supply circuit for providing an alternating current to a rotor winding of a resolver, and a processor configured to derive a first sampling value by sampling a voltage induced in at least one stator winding of the resolver by the alternating current flowing in the rotor at a predetermined first phase of the excitation current; and to decide that the resolver is defective when the first sampling voltage value deviates significantly from a DC component of the induced voltage.

10. The resolver controller of claim 9, further comprising a calculator for deducing an angular position of the resolver from voltage samples taken from the stator windings.

11. A computer-readable storage medium having stored thereon a plurality of instructions which, when executed by a processor cause the processor to derive a first sampling value by sampling a voltage induced in the at least one stator winding by the alternating current flowing in the rotor at a predetermined first phase of the excitation current; and to decide that the resolver is defective when the first sampling voltage value deviates significantly from a DC component of the induced voltage.
